(19) United States
(12) Patent Application Publication
(10) Pub. No.: US 2009/0274426 A1
(43) Pub. Date: Nov. 5, 2009

(54) Fiber optic cable and method of manufacturing the same

(76) Inventor: Jason C. Lail, Conover, NC (US)

Correspondence Address: CORNING INCORPORATED, INTELLECTUAL PROPERTY DEPARTMENT, SP-TI-3-1, CORNING, NY, 14831, US

(21) Appl. No.: 12/150,656

(22) Filed: Apr. 30, 2008

(51) Int. Cl. G02B 6/44; C03C 25/10

(52) U.S. Cl. 385/105; 65/430

(57) ABSTRACT

A fiber optic cable is that includes at least one optical fiber and a protective layer generally disposed about the optical fiber. A cable jacket surrounds an outer surface of the protective layer, and a control layer is interposed between a portion of the protective layer and a portion of the cable jacket. The control layer includes one or more apertures extending therethrough, thereby creating a predetermined bond between the protective layer and the cable jacket. By way of example, the protective layer is an armor layer, buffer tube, or other suitable cable component where a predetermined bond to the cable jacket is desired so the craft can easily remove a portion of the cable jacket. The plurality of apertures can have any suitable size, shape, and/or arrangement for influencing the desired bond strength. A method of manufacturing the fiber optic cable is also disclosed.

### BACKGROUND OF THE INVENTION

1. Field of the Invention

The present invention relates generally to fiber optic cables and methods for manufacturing the same. More particularly, the invention is directed fiber optic cables having a cable jacket with a predetermined bond characteristic and methods for manufacturing the same.

2. Technical Background

Fiber optic cables are used to transmit telephone, television, and computer data information in indoor and outdoor environments. Outside plant fiber optic cables are designed for use in the outdoor environment, and should be robust enough to withstand effects such as cable bending, twisting action, and attack by rodents. Thus, an outside plant fiber optic cable typically includes one or more cable components to enhance the robustness of the same. For instance, an outside plant fiber optic cable may include an armor layer generally disposed about the optical fiber for inhibiting moisture and/or rodents from reaching a cable core. The armor layer is typically configured as a longitudinal tape formed about a portion of the fiber optic cable. The armor layer is formed from a metal tape such as steel tape or nonmetallic material such as plastic tape, and typically includes a seam where edges of the tape touch or remain in close proximity with respect to each other. The seam is typically formed by butting the edges of the armor layer together or overlapping the edges of the armor layer along the length of the fiber optic cable.

Thereafter, an outer jacket is applied around the armor layer for providing further environmental protection. The outer jacket typically is a plastic material that is extruded over the armor layer. Conventionally, an adhesive, such as a water-blocking glue or the like, is used between the outer jacket and the armor layer for bonding these cable components together. The adhesive also provides a water-blocking capability for inhibiting moisture from reaching the cable core. A fiber optic cable without adequate water-blocking capability can undesirably subject the optical fibers therein to damage and/or create a duct for the flow of water along the length of the fiber optic cable.

In the field, the craft often must enter the fiber optic cable to access one or more of the underlying layers of the fiber optic cable. For instance, if the armor layer includes an electrically conductive material, the craft usually electrically grounds the same to inhibit lightening strikes from destroying the fiber optic cable. Grounding the cable generally requires removing (i.e., stripping back) a portion of the cable jacket to provide access to the armor layer. Additionally, the craft may have to enter the fiber optic cable to reach the optical fiber for splicing and/or connectorization. However, the adhesive located between the cable jacket and the armor layer can make removal of the cable jacket time consuming and/or difficult. Moreover, the bond strength between the cable jacket and the armor layer can be unpredictable. Thus, the craft would welcome fiber optic cables that provides an easily removable cable jacket having a predictable bond strength with the underlying cable components, while still providing the required robustness and/or environmental protection.

### SUMMARY OF THE INVENTION

In one example aspect, a fiber optic cable is provided, including at least one optical fiber and a protective layer such as an armor layer, buffer tube, or the like generally disposed about the optical fiber. An outer jacket is disposed about the protective layer, and a control layer is interposed between a portion of the protective layer and a portion of the outer jacket. The control layer includes one or more apertures extending therethrough to influence a predetermined bond between the protective layer and the outer jacket. In other words, the control layer acts to influence and/or reduce the level of bonding between the outer jacket and the protective layer. The plurality of apertures of the control layer can have any suitable size, shape, and/or arrangement for influencing the desired predetermined bond between the outer jacket and the protective layer.

Also disclosed is a method of manufacturing a fiber optic cable using a control layer for creating a predetermined bond. The method includes the steps of providing at least one optical fiber and surrounding the optical fiber with a protective layer, and applying a control layer about at least a portion of the protective layer, wherein the control layer includes one or more apertures extending therethrough. The method also includes the steps of applying a cable jacket about the control layer, thereby creating a predetermined bond between the protective layer and the cable jacket. The concepts of the invention provide the craft with fiber optic cables that are quickly and easily accessible since a predictable predetermined bond is created, while still providing a robust cable design.

### BRIEF DESCRIPTION OF THE DRAWINGS

These and other features, aspects and advantages of the present invention are better understood when the following detailed description of the invention is read with reference to the accompanying drawings, in which:

FIG. 1 illustrates a perspective view of an explanatory fiber optic cable according to an aspect of the present invention;

FIG. 2 illustrates a cross-section of the fiber optic cable of FIG. 1 taken along line 2-2;

FIG. 3 illustrates a partial enlarged view of the fiber optic cable of FIG. 2;

FIG. 4 illustrates a plan view of an exemplary control layer similar to the control layer shown in the fiber optic cable of FIG. 1;

FIG. 5 illustrates another plan view of an exemplary control layer according to another aspect of the present invention;

FIG. 6 illustrates yet another plan view of an exemplary control layer according to another aspect of the present invention;

FIG. 7 illustrates still another plan view of an exemplary control layer according to another aspect of the present invention;

FIG. 8 illustrates another explanatory fiber optic cable according to another aspect of the present invention; and

FIGS. 9A-9D depict a series of sequential side views of explanatory steps for manufacturing an exemplary fiber optic cable according to the present invention.

### DETAILED DESCRIPTION OF THE PREFERRED EMBODIMENTS

The present invention will now be described more fully hereinafter with reference to the accompanying drawings in which example embodiments of the invention are shown. Whenever possible, the same reference numerals are used throughout the drawings to refer to the same or like parts. However, this invention may be embodied in many different forms and should not be construed as limited to the embodiments set forth herein. These example embodiments are provided so that this disclosure will be both thorough and complete, and will fully convey the scope of the invention to those skilled in the art.

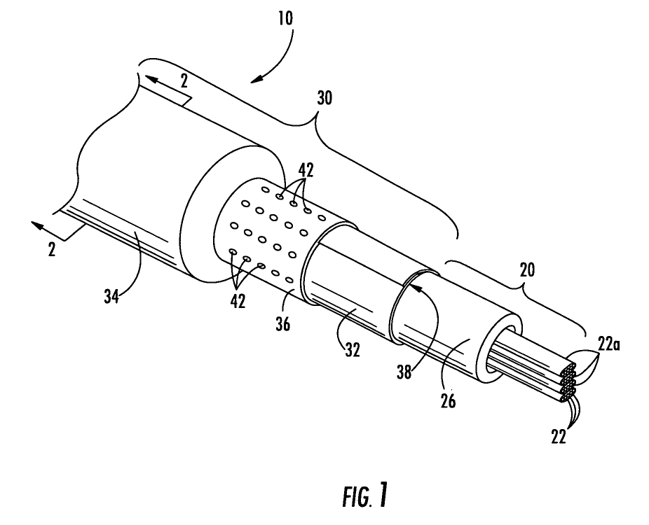

Referring now to FIG. 1, an explanatory fiber optic cable 10 according to one aspect of the present invention will be described. Fiber optic cable 10 generally includes a cable core section 20 and a jacket section 30, though it can also include various other sections, cable components, etc. Jacket section 30 includes a control layer 36 interposed between a portion of a protective layer 32 such as a metallic armor (or protective cable component) and a cable jacket 34. Control layer 36 has one or more apertures 42 for creating a predetermined bond between protective layer 32 and cable jacket 34 as discussed in more detail herein. Generally speaking, the control layer reduces the bond between the cable jacket and the underlying protective layer by allowing bonding at one or more discrete points instead of forming an annular continuous bond with the cable jacket. Fiber optic cables using control layer 36 are advantageous because they provide a cable jacket with a predetermined bond to underlying cable components, thereby allowing the craft quick and easy removal of the cable jacket, while still providing a robust design.

Cable core section 20 includes at least one optical fiber 22 and can have any suitable configuration. As depicted, fiber optic cable 10 includes optical fibers 22 formed as optical fiber ribbons 22a as known in the art. Optical fiber ribbons 22a are arranged as a ribbon stack (not numbered) disposed in a buffer tube 26. Although, cable core section 20 of fiber optic cable 10 is depicted as a central tube design, it can have other suitable configurations. For instance, cable core section 20 can have a loose tube construction with optical fibers disposed in one or more buffer tubes that are stranded along the length of the fiber optic cable. Other variations for cable core section 20 include one or more optical fibers disposed in a slotted core, flat ribbon cable, or other configurations as known in the art such as single fiber cable designs. Further, cable core section 20 can include one or more water-blocking components such as a thixotropic gel or grease in buffer tube 26 or outside buffer tube 26 as a flooding compound. Other variations of cable core section 20 include a dry cable core section that is free of thixotropic gel or grease and instead may use water-swellable tapes, yams, or powders. Additionally, cable core section 20 may include optional cable components such as strength members like tensile yams such as fiberglass rovings, aramid, or the like.

As depicted, jacket section 30 includes protective layer 32, control layer 36 and cable jacket 34 disposed about cable core section 20. Of course, jacket section 30 can include other configurations and/or cable components such as strength members, water-blocking components, and/or ripcords. In this embodiment, protective layer 32 is a metallic armor tape such as a steel tape, thereby providing a robust cable that can withstand attack by rodents and inhibit the migration of moisture into the cable core. Protective layer 32 can also optionally include various surface features, such as corrugation or the like and/or may have one or more coatings thereon. Other embodiments can have other suitable materials and/or components for protective layer 32. For instance, protective layer 32 may be formed of other types of metal tapes such as aluminum. Other material variations for protective layer 32 include plastic, rubber, fabric, composite tapes having conductive and non-conductive materials, or other suitable cable components. By way of example, the armor protective layer 32 of fiber optic cable 10 may be eliminated so that buffer tube 26 becomes the protective layer that is bonded to cable jacket 34 using control layer 36. As shown, protective layer 32 includes a seam 38 where edges of the tape touch or remain in close proximity with respect to each other. The seam may be, for example, an edge-to-edge configuration or an overlap configuration formed by longitudinally overlapping edges of the tape. A seam guard (not shown) can be placed over seam 38 for inhibiting tearing of cable jacket by the edges of the armor when the cable is bent or the like (e.g., inhibits zippering of seam/tearing of the cable jacket) and/or provides a water-blocking function inhibiting the ingress of moisture into the cable core.

Protective layer 32 is generally disposed about a portion of cable core section 20. For instance, as shown, protective layer 32 generally surrounds and contacts the buffer tube 26, but it could generally surround a stranded tube section, slotted core, or a tight-buffer layer of a single fiber cable. In addition or alternatively, jacket section 30 can include a plurality of protective layers 32. In one example, a plurality of non-contiguous protective layers 32 can be included that are each disposed about a portion of the cable core section 20. In another example, a plurality of protective layers 32 can be arranged radially and/or axially spaced from each other, and may include various other layers therebetween. However, for clarity, only a single control layer 36 and single cable jacket 34 will be discussed herein, with the understanding that such discussion can similarly apply to a plurality of control layers 36.

Cable jacket 34 is depicted as an outer jacket; but, it is possible for the cable jacket having the predetermined bond to form one or more inner jackets (not shown). Specifically, cable jacket 34 comprises an outer jacket that generally surrounds an outer surface of protective layer 32. Cable jacket 34 can include suitable material, such as a plastic, e.g. a polyethylene (PE), polypropylene (PP), a PVC material, or other materials such a rubber, TPU, polymer blends, or the like. Further, cable jacket 34 can include a flame-retardant additive or material to form a flame-retardant polyethylene or the like. Cable jacket 34 is extruded about the other cable components, thereby forming the predetermined bond, as will be discussed more completely below.

The concepts of the present invention are useful since the craft often must remove some or all of cable jacket 34 for providing access to one or more cable components of jacket section 30 and/or cable core section 20. For example, where the protective layer 32 includes a metallic, electrically-conductive material, the craft typically removes a portion of cable jacket 34 for electrically grounding the conductive element. Additionally, the craft may also require access to optical fibers 22 of cable core section 20 for connectorizing, splicing, etc. Thus, fiber optic cable 10 is beneficial since it provides a predetermined bond strength between cable jacket 34 and one or more underlying layers that act as the protective layer 32, thereby facilitating the stripping and/or removal of cable jacket 34 from fiber optic cable 10 in a consistent and reliable manner.

Control layer 36 can include any suitable material(s) that allows the creation of a predetermined bond. As shown, control layer 36 is configured as a tape or the like such as a sheet, fabric, film, and may include one or more coatings or binder threads for securing the same before applying the cable jacket. More specifically, control layer 36 can include a material selected from the group consisting of polyimides and/or polyethylene terephthalates (PET), such as materials sold under the trade name Mylar® or Kaptron®, though other materials are also possible. Other suitable materials for control layer 36 include metal or dielectric materials such as rubber, and/or plastic. Since cable jacket 34 is applied in a molten state during extrusion, control layer 36 is preferably selected from a material having a melting point temperature higher than the melting point temperature of cable jacket 34 material so that the extrusion process does not melt the control layer.

To create the predetermined bonding, control layer 36 includes at least one aperture 42, such as a hole, gap, or slit, or the like extending therethrough for allowing the molten material of cable jacket 34 to extend therethrough during manufacturing in a manner to create a predetermined bond strength. Preferably, control layer 36 includes a plurality of apertures 42 extending therethrough with a desired geometry (i.e., shape and/or size) for influencing the amount and/or rate of molten material that contacts protective layer 32. Any or all of the apertures 42 can have various geometries that are similar, identical and/or different from one another. By way of example, apertures 42 can have a generally round geometry with the same and/or different diameters. In another example, apertures 42 can have other geometries, such as an oval, ellipse, or polygon shapes such as square, rectangular, triangular, or other suitable shapes. Still further, apertures 42 can have an elongated geometry, such as a slit, slot, or the like. Apertures 42 can also have various sizes, relative orientations, etc. as will be discussed more fully herein.

Any or all of the apertures 42 can be at least partially or completely formed in control layer 36 prior to application of the same about protective layer 32. Moreover, apertures 42 can be formed in the control layer 36 with any known technique(s), such as mechanical, electrical, chemical, laser-based techniques, etc. For example, apertures 42 can be formed in control layer 36 as a prior, separate manufacturing process prior to the manufacture of fiber optic cable 10. Alternatively, any or all of the apertures can be at least partially or completely formed in control layer 36 during manufacture of fiber optic cable 10. For example, as control layer 36 is applied onto the protective layer 32, a laser or the like can be used to form apertures 42, though various mechanical, electrical, chemical, etc. procedure can also be used.

Each aperture 42 can create a separate, individual bond between protective layer 32 and cable jacket 34. Thus, when control layer 36 includes a plurality of apertures 42, the predetermined bond strength is intended to refer to the sum total strength for all of the individual bonds over a given area. As a result, a generalized mathematical formula for describing the individual bond strength can be described as: Individual Bond Strength=(Modulus of Elasticity of the Bonding Material (i.e., the cable jacket material))×(Area of Application of a Single Bond). Similarly, a generalized mathematical formula for describing the predetermined bond strength can be described as: Predetermined Bond Strength=(Modulus of Elasticity of the Bonding Material)×(Area of Application of a Single Bond)×(Total number of Bonds). Thus, where the modulus of elasticity of the bonding material is maintained as a constant, as is generally the case for specific materials, the predetermined bond strength can be adjusted by altering the total area of application of the bonds. For example, a relative increase in the total area of application of the bonds increases the predetermined bond strength, while a relative decrease in the total area of application of the bonds causes a decrease in the predetermined bond strength.

The generalized formulas discussed above can be modified to account for apertures 42 having different geometries, sizes, relative orientations, etc. that likewise can provide different individual bond strengths. The generalized formulas can also be modified to account for different failure modes that may occur. For example, the formulas discussed above can apply to a material failure mode, wherein the material of cable jacket 34 (e.g., a plastic material or the like) itself fails because the variable representing the Modulus of Elasticity reflects the internal tear strength of the material. In another example, the formulas can be modified to represent a bond failure mode, wherein the bond between cable jacket 34 and control layer 36 fails. In such an example, the Modulus of Elasticity of cable jacket 34 can be replaced with a variable representing the adhesive force or separation force between cable jacket 34 and control layer 36, which may vary depending upon the materials used. Similarly, the separation force provided by the various generalized formulas can represent the material failure mode, or even the bond failure mode.

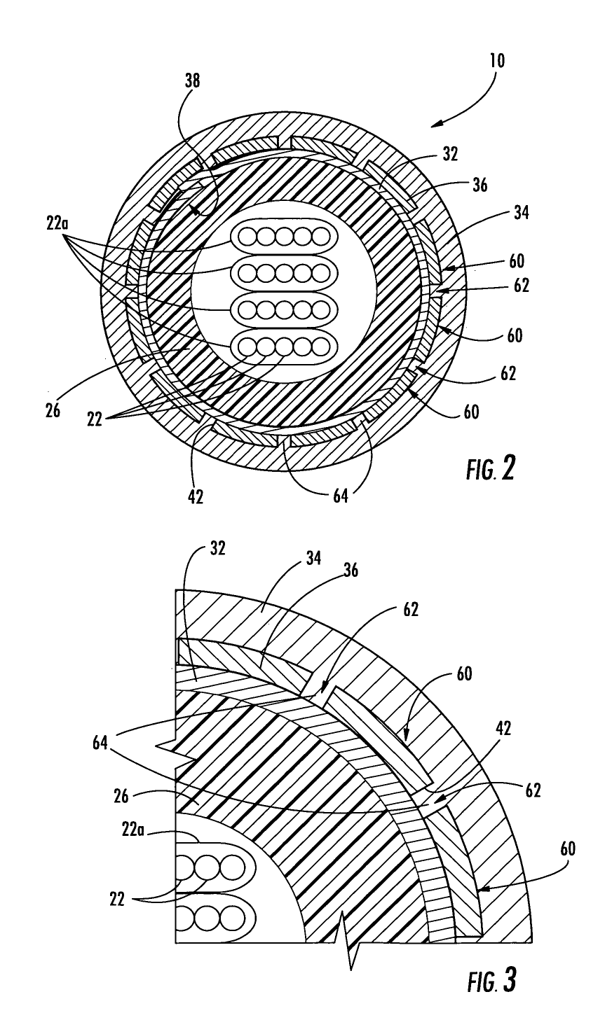

Turning to FIG. 3, which illustrates an enlarged quarter-sectional view of FIG. 2, apertures 42 of control layer 36 create a predetermined bond between protective layer 32 and cable jacket 34. As shown, apertures 42 provide an intermittent bond between protective layer 32 and cable jacket 34 by inhibiting full contact between the two. That is, a portion 60 of control layer 36 void of aperture 42 generally inhibits, such as prevents, a direct bond between cable jacket 34 and protective layer 32. In contrast, a portion 62 of control layer 36 including an aperture 42 permits a direct bond, via the aperture 42, between the molten cable jacket 34 and protective layer 32 during manufacturing. Specifically, where an extrusion molding process is used to apply cable jacket 34 about control layer 36, the cable jacket 34 material is initially introduced onto control layer 36 in at least a partially-molten state. A portion of the molten cable jacket material that is in contact with portion 60 of control layer 36 is generally inhibited, such as prevented, from forming a direct bond with protective layer 32. Instead, the cable jacket 34 material creates a predetermined bond between control layer 36 and cable jacket 34 about portion 60. In other variations, either or both of protective layer 32 and control layer 36 can be heated, and a relatively cooler cable jacket 34 can be applied thereto. Upon contact, the relatively hotter protective layer 32 and/or control layer 36 will melt at least a portion of cable jacket 34 to form the bond between cable jacket 34 and protective layer 32.

However, the portion of the molten cable jacket 34 material that is in contact with portion 62 of control layer 36 is permitted to create a direct bond with protective layer 32 via aperture 42. As shown, the molten cable jacket 34 extends into each of the plurality of apertures 42 of control layer 36, thereby creating a plurality of individual bonds 64 with protective layer 32 once the cable jacket 34 material cools into a generally solid state. The molten cable jacket 34 material, being in a generally viscous state, flows into and assumes the geometry of each aperture 42. Thus, as discussed above, the predetermined bond strength between the cable jacket 34 and protective layer 32 can be equal to the sum total strength for all of the individual bonds 64 over a specific area. Additionally, because the molten cable jacket 34 material can generally completely fill each aperture 42, the apertures 42 can be partially or completely sealed with regards to water or other contaminants to provide an inherent water-blocking feature.

The individual and/or total bond strengths can vary to provide different desired bond strengths by tailoring apertures and/or material selection of cable jacket 34/protective layer 32. By way of example, as shown in FIGS. 2-3, approximately ten to twelve apertures 42 can be spaced radially about a portion of control layer 36. Each aperture 42 can have a diameter of about two millimeters or less. Each aperture can provide approximately one and one-half pounds (i.e., 6.67 Newtons) of bond strength, yielding a total bond strength of approximately 18 pounds (i.e., 80.07 Newtons) for the twelve apertures.

In another example, approximately ten apertures 42 can be spaced radially about a portion of the control layer 36. Each aperture 42 can have a diameter of about one and one-half millimeters or less. Thus, the apertures 42 can provide a bond strength of approximately 6.7 Newtons per square millimeter. Thus, it is possible to tailor the apertures to provide bond strengths between about 3 to about 9 Newtons per square millimeter, but other bond strength values are possible. Additionally, besides the radial spacing of apertures, the longitudinal spacing among apertures can also effect the bond strength on a per length basis. The separation forces described in the examples can represent the material failure mode, or even the bond failure mode, on either an individual or total basis.

Moreover, various numbers of apertures 42 having various cross-sectional areas and providing various individual bond strengths are possible. For example, ten or less apertures 42 can be radially spaced about a portion of control layer 36. In another example, each aperture 42 can have a diameter of less than approximately three millimeters, one millimeter, or even one-half millimeter. In other variations, each aperture 42 can provide an individual bond strength of approximately one-half pound (i.e., 2.22 Newtons). Thus, the concepts of the spacing, size, and/or number of apertures 42 can provide predetermined bond strengths greater than, less than, or equal to those discussed above as desired.

In addition or alternatively, one or more adhesives (not shown) can also be used between cable jacket 34 and protective layer 32. For example, an adhesive can be applied to an outer surface of the control layer 36 prior to application of the cable jacket 34. Likewise, various other cable components, such as a water-blocking tape and/or gel could be applied for further increase resistance to water damage for fiber optic cable 10. Although, not shown fiber optic cable 10 can also include one or more strength members as a portion of cable core section 20 and/or jacket section 30 such as aramid yarns, fiberglass, and/or glass-reinforced plastic (GRPs).

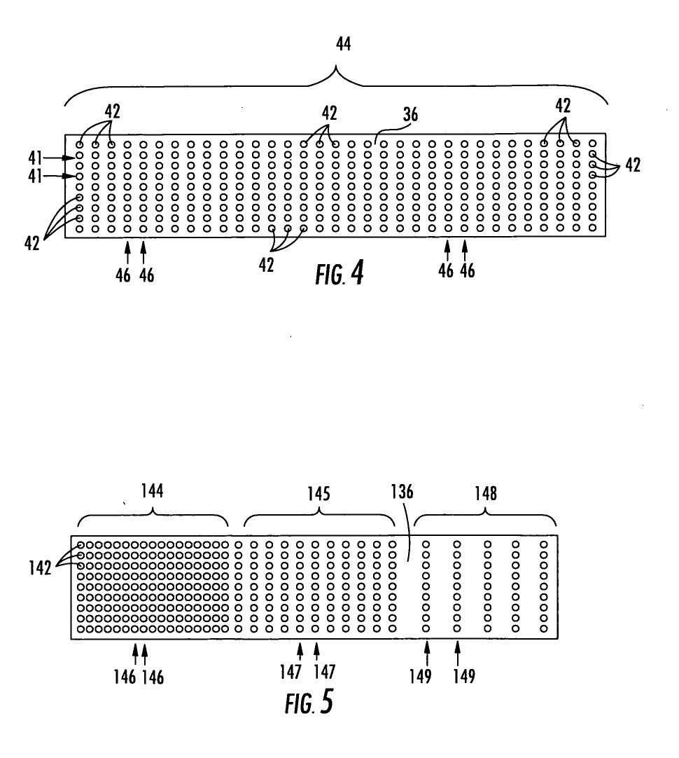

Turning now to FIGS. 4-7, exemplary control layers are depicted showing the plurality of apertures 42 configured, individually or in groups, to alter the total area of apertures that influence the bond strength. FIG. 4 shows the plurality of apertures 42 arranged on control layer 36 in a array 44 that is generally uniform matrix. The matrix has a plurality of rows 41 and/or columns 46 of apertures that are spaced a first distance from one another. However, the array of apertures can having other patterns, spacings, and/or sizes of various geometric shapes to influence the bond strength based on the needs of the craft. Illustratively, FIGS. 5-6 depict other between various rows 41 and/or columns 46 of apertures arranged in different patterns. Additionally, either of the rows 41 and/or columns 46 can be aligned or transverse with respect the length of the control layer 36.

Specifically, FIG. 5 depicts a plurality of apertures 142 arranged in at least a first array 144 having a first bonding characteristic, and a second array 145 having a second bonding characteristic that is different from the first bonding characteristic. The plurality of apertures 142 can also be arranged in additional arrays, such as a third array 148 having a different, third bonding characteristic. Altering the bonding characteristic can result in different predetermined bond strengths along the length of control layer 136.

For example, the columns 146 of the first matrix can be spaced a first distance from each other, while the columns 147 of the second matrix can be spaced a second distance from each other to provide a different density of apertures 142 in the second array 145 per length of control layer 136. In other words, the apertures 142 are arranged in a plurality of arrays 144, 145, 148 each having a plurality of columns 146, 147, 149 of apertures that are spaced at different distances. As shown, columns 147 of the second array 145 can be spaced farther apart than columns 146 of the first array 144, while columns 149 of the third array 148 are spaced farther apart than columns 147 of the second array 145.

As a result, where the cross-sectional size and shape of apertures 142 are the same, the relatively greater density of apertures 142 in the first array 144, as compared to the second array 145, provides for a greater bond area (e.g., the area of application of a single bond multiplied by the total number of bonds) in the first array 144. Thus, according to the aforedescribed mathematical formula, the predetermined bond strength in the first array 144 will be greater than the bond strength of the second array 145 with everything else being equal. Similarly, the predetermined bond strength in the third array 148 will be less than that of either the first or second arrays 144, 145. More generally stated, over the same surface area of control layer 136 and with the same size apertures 142, a first array 144 of apertures 142 having a relatively greater density will provide a relatively greater bond strength as compared to a second array 145 of apertures 142 having a relatively lesser density.

Turning now to FIG. 6, arrays of apertures 242, 243 can have configurations that produce a varying bonding characteristic along the length of the control layer. As shown, control layer 236 has two different repeating patterns of apertures 242, 243 with each pattern having a different number, size, and spacing for the apertures to create different bonding characteristics between the patterns. As shown, a first array 250 includes a plurality of apertures 242 arranged in a first matrix of spaced columns 252, while the second array 254 includes a plurality of apertures 243 arranged in a second matrix of spaced columns 256. Specifically, the individual apertures 242 of first array 250 have a smaller cross-sectional area than the cross-sectional area of the individual apertures 243 of second array 254.

Consequently, the individual bond strength provided by each aperture 243 of second array 254 will be relatively greater than the individual bond strength provided by each aperture 242 of first array 250. However, the total bond strength provided by the first array 250 may be less than, greater than, or equal to the total bond strength provided by the second array 254 depending upon the total bond area provided by the total number of apertures 242, 243 of each array 250, 254, respectively. Moreover, the predetermined bond strength provided by the combination of the first and second arrays 250, 254 can be determined by summing the net total bond strength provided by each respective array 250, 254.

Thus, one way of influencing/tailoring the bonding characteristic is by a selecting a predetermined percentage of the total aperture area (i.e., the pass-thru area defined by the total area of all the apertures) relative to the total perimeter area of the control layer (i.e., the total area bounded by the edges of the control layer) of per unit length. For example, the desired bonding characteristic can require that approximately twenty-five percent or less of the total perimeter area of control layer 36 is covered by apertures 42 to form a total aperture cross-sectional area, but other higher or lower percentages are possible. By way of example, if a control layer has width of about 5 centimeters, then a perimeter area is about 500 square centimeters per meter length (i.e., 5 centimeters times 100 centimeters) and a 25% total aperture area (i.e., pass-thru area) is about 125 square centimeters per meter length. In other embodiments, the plurality of apertures can define a total cross-sectional area that is less than or equal to about fifteen percent of a total perimeter area of the control layer. In other examples, the apertures 42 can have a total aperture cross-sectional area that is about ten percent or less, such as five percent, three percent, or even one percent of the total perimeter area of the control layer, but other percentages are possible based on the desired bonding level. The percentage of aperture area coverage can be altered variously, such as by increasing the size, number, and/or density of the apertures 42, and/or the size of the control layer 36, etc. Further, the percentage of aperture coverage can vary along different portion of the fiber optic cable 10, such as providing a relatively lower percentage of apertures 42 area along a section that is intended to be relatively less difficult to remove, and a relatively higher percentage of apertures 42 area along a section that is intended to be relatively more difficult to remove (e.g., see FIG. 7). Moreover, it is to be appreciated that, although the various bonding characteristics are discussed herein with reference to a generally planar geometry, the various bonding characteristics can also be differentiated with reference to a generally radial geometry.

The various arrays 144, 145, 148 of apertures 142 of FIG. 5 are illustrated on a single control layer 136 to emphasize the relative column spacing. Similarly, the various arrays 250, 254 of apertures 242, 243 of FIG. 6 are illustrated on a single control layer 236 to emphasize the relative cross-sectional area of the apertures 242, 243. However, any of the various arrays described herein may or may not be on a single control layer. For example, a first type of fiber optic cable may require a relatively different predetermined bond strength than a second type of fiber optic cable, and as a result, would have a correspondingly different control layer or configuration of apertures. For instance, a single fiber optic cable may require relatively different predetermined bond strength along discrete portions of the same, and as a result, would have a correspondingly different configuration of apertures along each discrete portion.

Illustratively, FIG. 7 depicts a control layer 336 suitable for stripping back or removal of a top portion of cable jacket 34, while inhibiting stripping back or removal of a bottom portion of cable jacket 34 by using extremely different aperture portions. Though described in a generally planar configuration in FIG. 7, the top portion 337 and bottom portion 339 of control layer 336 refer to respective radial locations on the control layer 336 when about protective layer 32 (see FIG. 1). As shown, apertures 342 that meet near a top portion 337 (i.e., at the edges) of control layer 336 provide a configuration yielding a relatively lower predetermined bond strength, while the relatively large apertures 335 of control layer 336 provide a configuration yielding a relatively higher predetermined bond strength (i.e., a majority of the molten cable jacket of this portion can bond with the protective layer). By way of numeric example, apertures 342 adjacent the top portion 337 can provide about ten percent of total aperture area (i.e., pass-thru area), while apertures 335 provide about eighty percent total aperture area using one or more large window apertures. Of course, various other percentages, ratios, geometries are possible with the dual high/low level bonding concept. Moreover, apertures 342 adjacent the top portion 337 can be arranged in any suitable array similar to those discussed previously herein. Likewise, the aperture(s) 335 can have other suitable configurations for providing a relatively high bond strength. Still, it is to be appreciated that any of the apertures discussed herein can also be arranged in various other manners on any suitable control layer, including being randomly arranged.

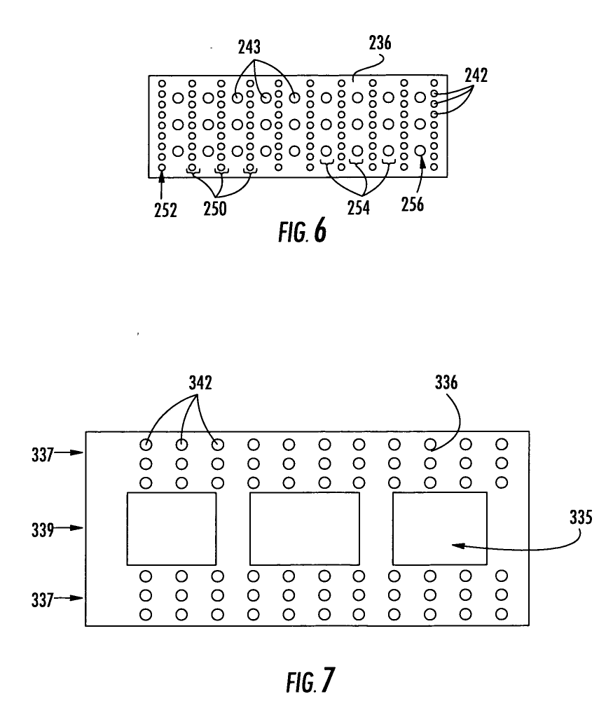

FIG. 8 depicts a fiber optic cable 400 having a control layer 436 that covers less than the entire perimeter of a protective layer 432 disposed under cable jacket 434, thereby providing a preferential access location. As shown, fiber optic cable 400 is a non-round cable design having a non-stranded ribbon stack disposed within a cavity. Control layer 436 is disposed over a seam (not numbered) of protective layer 432 such as a seam formed by an armor protective layer. Consequently, the portion of cable jacket 434 over the seam (or the top half of fiber optic cable 400) has a lower bond strength than the portion of cable jacket that is not disposed over control layer 436. Locating the lower bond strength portion of cable jacket 434 over the seam of the protective layer is advantageous because the craft can easily and quickly remove the portion of cable jacket 434 adjacent the seam. In other words, the craft can easily remove or access a portion of the cable jacket adjacent the seam, thereby allowing opening and/or removal of a portion of the protective layer to provide access to cable core section that has the optical fibers. Other variations can one or more multiple control layers that cover less than the entire perimeter of the protective layer. For instance, three individual control layers may be disposed about the protective layer and cover less than the entire perimeter of the protective layer. Further, control layer(s) can have over locations for removing a portion of the cable jacket at preferential access locations. For instance, fiber optic cables can have control layers disposed over strength members, ripcords, and/or buffer tubes. Other variations include locating the control layer under a print statement or the like so that the craft knows where the lower bond strength is located before attempting to open the fiber optic cable.

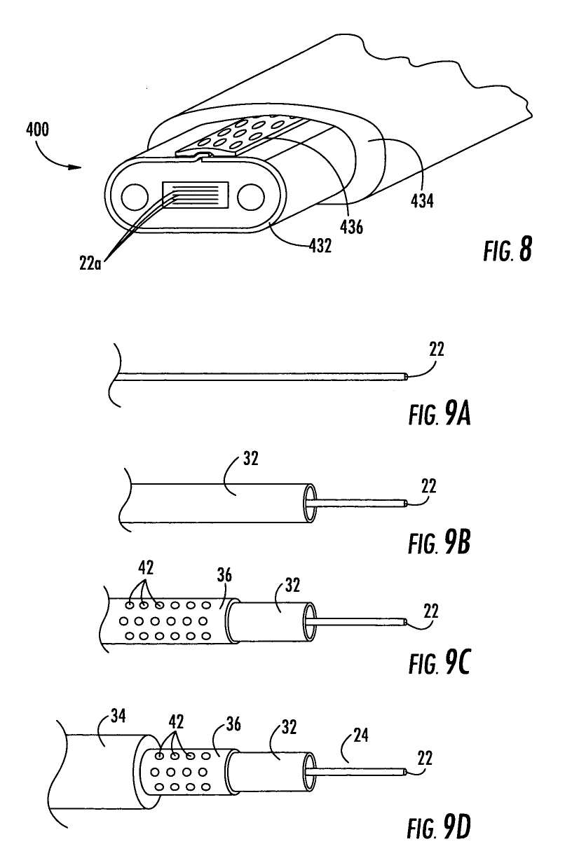

Turning now to FIGS. 9A-9D, an example method of manufacturing fiber optic cables will now be discussed. As shown in FIG. 9A, the method generally includes the step of providing at least one optical fiber 22 that forms a portion of cable core section 20. As shown in FIG. 9B, the method further includes the step of surrounding optical fiber 22 with a protective layer 32 such as a buffer tube, a tight-buffer layer, armor layer, or the like. Next, as shown in FIG. 9C, the method includes the step of applying control layer 36 having at least one aperture 42 about a portion of protective layer 32. Thereafter, as shown in FIG. 9D, the method includes the step of applying a cable jacket 34 about control layer 36, thereby creating a predetermined bond between the protective layer 32 and cable jacket 34. As discussed herein, the control layer includes a plurality of apertures 42 extending therethrough, thereby creating a predetermined bond between protective layer 32 and cable jacket 34. The method described can also include more or less other steps, cable components and/or as various pre-processing or post-processing steps. Additionally, the method can include any or all of the procedures, materials, etc. previously described herein, and/or can include various additional steps, methods, procedures, materials, etc.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

1. A fiber optic cable including:
at least one optical fiber;
a buffer tube disposed about the at least one optical fiber;
a metallic armor layer generally disposed about and contacting the buffer tube;
an outer jacket disposed about and contacting the metallic armor layer; and
a control layer interposed between the armor layer and an inner surface of the outer jacket, an inner surface of the control layer contacting an outer surface of the armor layer,
wherein the control layer includes a plurality of apertures extending therethrough to create a predetermined bond between the armor layer and the outer jacket, and wherein
a portion of the outer jacket extends into the plurality of apertures of the control layer and is bonded with the metallic armor layer.

2. The fiber optic cable of claim 1, wherein the plurality of apertures is arranged in at least one array of apertures.

3. The fiber optic cable of claim 2, wherein the at least one array of apertures includes a first array of apertures including a first bonding characteristic and a second array of apertures including a second bonding characteristic that is different from the first bonding characteristic.

4. (canceled)

5. The fiber optic cable of claim 1, wherein the plurality of apertures define a total cross-sectional area that is less than or equal to twenty-five percent of a total perimeter area of the control layer.

6. A fiber optic cable including:
at least one optical fiber;
a protective layer generally disposed about the at least one optical fiber;
a cable jacket surrounding an outer surface of the protective layer; and
a control layer interposed between a portion of the protective layer and an inner surface of the cable jacket, wherein
the control layer includes a plurality of apertures extending therethrough to create a predetermined bond between the protective layer and the cable jacket,
the plurality of apertures are arranged in a first array of apertures including a first bonding characteristic, and in a second array of apertures including a second bonding characteristic that is different from the first bonding characteristic, the first array including a first matrix and the second array including a second matrix, and
the first matrix includes a plurality of columns of apertures that are spaced a first distance from one another and the second matrix includes a plurality of columns of apertures that are spaced a second distance from one another, wherein the second distance is greater than the first distance.

7. The fiber optic cable of claim 6, wherein a portion of the cable jacket extends into the plurality of apertures of the control layer, and wherein the portion of the cable jacket is bonded with the protective layer.

8.-12. (canceled)

13. The fiber optic cable of claim 6, wherein the protective layer is an armor layer.

14. The fiber optic cable of claim 6, wherein the control layer includes a material selected from the group consisting of polyimides and polyethylene terephthalates.

15. The fiber optic cable of claim 6, wherein the control layer includes a flexible sheet.

16. The fiber optic cable of claim 6, wherein the plurality of apertures define a total cross-sectional area that is less than or equal to twenty-five percent of a total perimeter area of the control layer.

17. A method of manufacturing a fiber optic cable, including the steps of:
providing at least one optical fiber;
forming a buffer tube about the at least one optical fiber;
surrounding an outer surface of the buffer tube with a metallic protective layer that contacts the outer surface of the buffer tube;
after surrounding the outer surface of the buffer tube with the protective layer, applying a control layer onto at least a portion of an outer surface of the protective layer, wherein the control layer includes a plurality of apertures extending therethrough; and
extruding a cable jacket about the control layer, wherein
the cable jacket is extruded from a molten material so that a portion of the molten material extends through the plurality of apertures of the control layer and bonds with the protective layer and creates a predetermined bond between the protective layer and the cable jacket.

18. (canceled)

19. The method claim 21, wherein the cable jacket includes a material having a melting point temperature, and wherein the control layer includes a material having a melting point temperature higher than the melting point temperature of the cable jacket material.

20. The method of claim 19, wherein the plurality of apertures are formed in the control layer prior to extrusion of the control layer onto the protective layer.

21. The fiber optic cable of claim 17, wherein the control layer includes a material selected from the group consisting of polyimides and polyethylene terephthalates.

22. The fiber optic cable of claim 1, wherein the control layer includes a material selected from the group consisting of polyimides and polyethylene terephthalates.
